(19) United States
(12) Patent Application Publication
(10) Pub. No.: US 2002/0091840 A1
(43) Pub. Date: Jul. 11, 2002

(54) Real-time optimization of streaming media from a plurality of media sources

(76) Inventors: Gregory Pulier, Los Angeles, CA (US); John David Busfield, Valencia, CA (US)

Correspondence Address: Jones, Day, Reavis and Pogue, North Point, 901 Lakeside Avenue, Cleveland, OH, 44114, US

(21) Appl. No.: 09/996,084

(22) Filed: Nov. 28, 2001

Related U.S. Application Data
(60) Provisional application No. 60/253,573, filed on Nov. 28, 2000.

(51) Int. Cl. G06F 15/16

(52) U.S. Cl. 709/228; 709/219

(57) ABSTRACT

A client-side apparatus and method for handling media capable of being provided by a plurality of provider computer systems to a client computer. A client-side sniffer module determines capabilities of the client computer related to handling the media. A first provider computer system is selected based upon the determined capabilities of the client computer, and a network connection is established so that the selected first provider computer system may provide the media to the client computer. A client-side metrics calculator module examines a connection characteristic of the network connection. A client-side stream switcher module ceases delivery of the media from the first computer provider based upon the examined connection characteristic satisfying a preselected criterion, and selects a second computer provider to deliver the remaining portion of the media to the client computer.

### RELATED APPLICATION

This application claims priority to U.S. provisional application serial No. 60/253,573 entitled “Real-Time Optimization of Streaming Media from a Plurality of Media Sources” filed Nov. 28, 2000. By this reference, the full disclosure, including the drawings, of U.S. provisional application Serial No. 60/253,573 is incorporated herein.

### BACKGROUND

1. Technical Field

The present invention is directed to the field of data communication. More specifically, the present invention provides a system and method for optimizing a streaming media download from a plurality of host media sources, where the optimization occurs in real-time as the media is being received at a client system.

2. Description of the Related Art

The recent increase in demand for streaming media over the Internet has caused rapid growth in the number of companies providing streaming media services. Companies such as Intervu, Akamai and SandPiper have begun developing systems to provide the efficient delivery of streaming media to the end user and avoid the current bottlenecks that negatively impact the delivery of such media.

Intervu was granted a U.S. Pat. No. 6,003,030, entitled “System and Method for Optimized Storage and Retrieval of Data on a Distributed Network.” This patent describes just one of the methods companies like Intervu are using to try to effectively provide streaming media. It covers solutions that deliver audio, video, graphics, and other computer data over the Internet from the server or delivery center that is electronically closest to the end user-this is called the distributed server model. Another method is called the central server model, which provides access to streaming media through centralized server facilities that have access to large amounts of bandwidth. Still other methods provide access to streaming media using satellite systems.

Because the desired result is to provide the end user with the best possible viewing experience, and because current provider solutions do not use metrics originating from the end user's system, the providers cannot claim that their system of streaming media delivery is optimal. Providers are typically using metrics coming from the end user's Internet Service Provider (ISP), which is still a step away from the end user's system, and therefore, cannot provide an optimal end user viewing experience.

### SUMMARY

A Multiple Provider Hosting (MPH) system is provided which optimizes the end user's viewing experience. The MPH system establishes an account with several streaming media providers. An instance of streaming media is uploaded to all providers who might, based upon their distribution system, optimize delivery of the media. When an end user wants to access the media content, the MPH client-based system uses end user metrics and provider availability to select the best streaming media provider to deliver the media content to that particular end user at that particular time. The MPH system allows streaming media to be continuously played at the desired bandwidth, such that the end user experience is optimized throughout the entire media content. During media play, and in real-time, provider bandwidth is monitored, and if it falls below a specified percentage of the required bandwidth, the MPH system switches hosting to the next provider that meets the bandwidth criteria. Furthermore, the MPH system gathers end user viewing statistics, and stores these statistics for analysis and use in future advancements of its technology.

### BRIEF DESCRIPTION OF THE DRAWINGS

FIG. 1 is a block diagram depicting computer and software components used in optimization of streaming media from a plurality of media sources; and

FIGS. 2-4 are flow charts depicting steps used in optimization of streaming media from a plurality of media sources.

### DETAILED DESCRIPTION

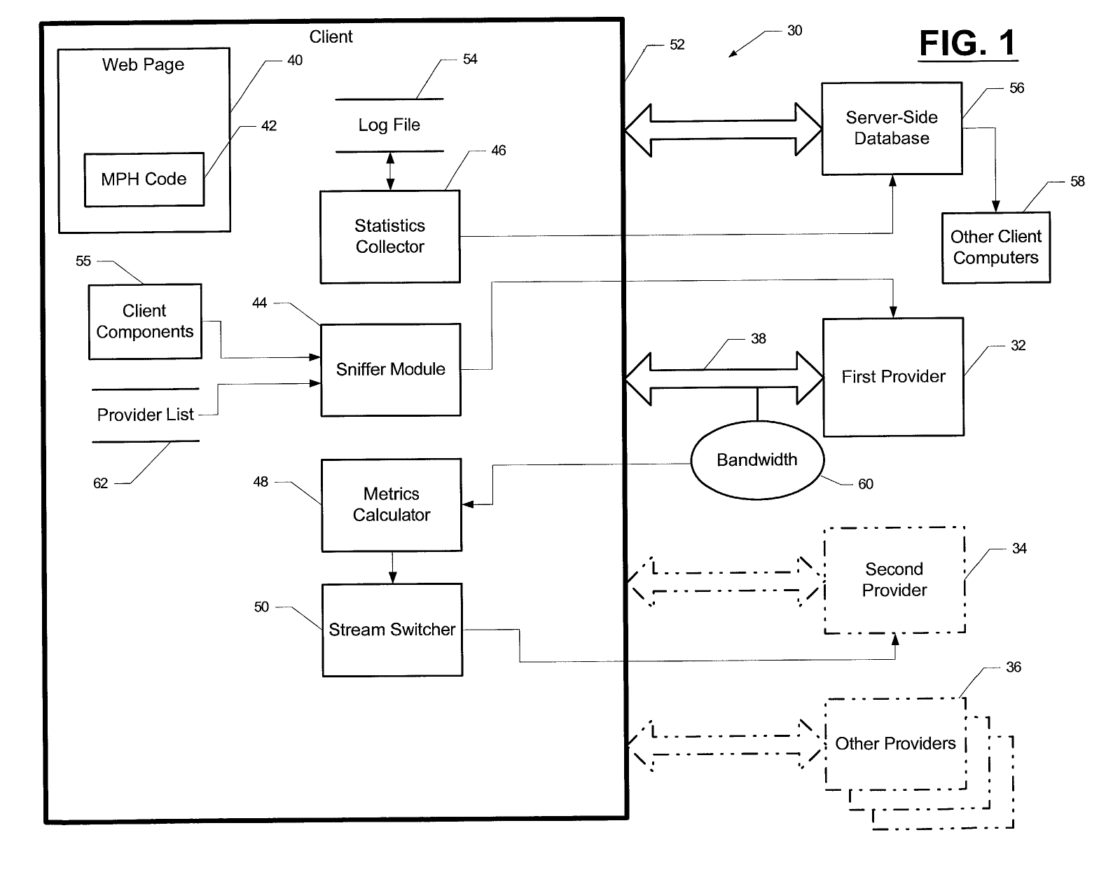

FIG. 1 depicts at 30 a Multiple Provider Hosting (MPH) system that achieves the best possible streaming media viewing experience. The MPH system 30 provides access to multiple provider computer systems (32, 34, 36) as potential hosts for streaming media content, as well as the ability to switch seamlessly between different hosts (32, 34, 36) during streaming media play. The media content may be delivered over many different types of network connections, such as an Internet connection 38, and may include many forms, such as video, audio, smell and combinations thereof.

The MPH system 30 is activated when a web page 40 requiring media delivery is executed. The web page 40 contains multiple provider hosting code 42 that alerts the MPH system 30 to begin its operations. The MPH system 30 includes a sniffer module 44, a statistics collector module 46, a metrics calculator module 48, and a stream switcher module 50. The MPH sniffer module 44 is a client-side module that is triggered by user access of the streaming media web page 40. It calculates the current bandwidth from the client machine 52 to a web page server, checks to see whether the client has the necessary components 55 (e.g., a proper media player, what monitor is to display the media, what audio components exist to render the audio data of the media, etc.). The information gathered by the sniffer module 44 gives the MPH system 30 an initial selection of a host computer to deliver the media The MPH statistics collector 46 is a client-side module that monitors a user's experience as they interact with the streaming media on a web page 40, and collects statistics about the user experience and stores them in a log file 54. Just before the associated web page 40 is exited, the statistics gathered by the MPH system 30 are sent to a server-side database 56 for storage and analysis. The analysis is useful for other client computers 58 in determining which provider computer systems (32, 34, 36) optimally deliver media under different conditions. Sniffer modules existing on the other client computers 58 use the analysis in establishing an initial provider computer system selection.

The metrics calculator module 48 is a client-side module that examines a connection characteristic (e.g., bandwidth delivery 60) of the network connection 38. During streaming of the media, the metrics calculator module 48 monitors bandwidth 60 of the streaming media being received on the client-side, and compares that measurement to a predetermined percentage of bandwidth considered to be the minimum required for an acceptable user experience.

If the metrics calculator module 48 determines the bandwidth 60 is below the acceptable level, then the stream switcher module 50 pauses the media stream, records the current play time of the media stream, and examines a list 62 of provider computer systems for the next available one to deliver the remaining portion of the media.

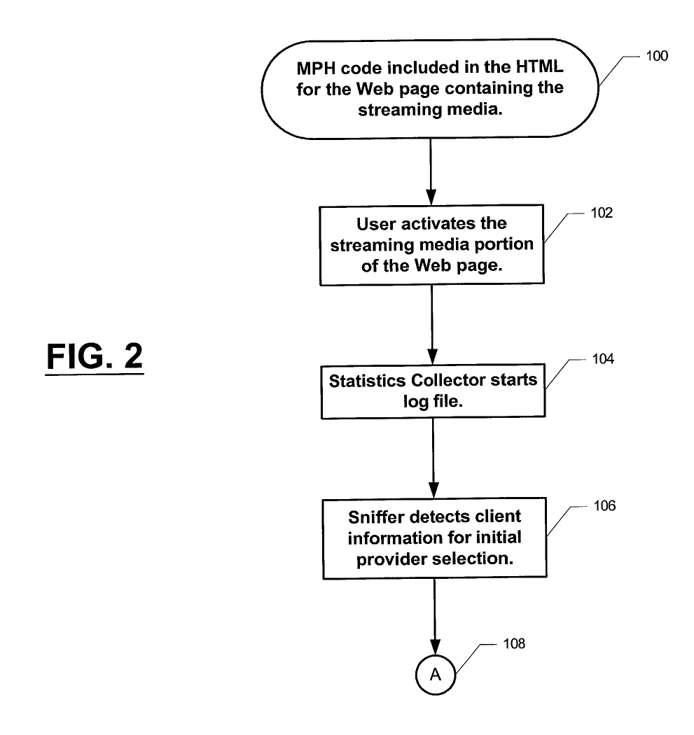

The flowcharts in FIGS. 2-4 depict in greater detail the MPH system process. With reference to step 100 on FIG. 2, a preliminary step in the MPH process is the addition of MPH code to the hypertext markup language (HTML) code for the streaming media file. The MPH code allows the MPH functionality to be applied to a streaming media on a web page. The lines of MPH code can be added directly to the HTML code, or can be inserted via web media authoring/synchronization tools, such as are available from Interactive Video Technologies located in New York. Once the MPH code is contained in the HTML code for the streaming media, the MPH process is triggered (at step 102) any time a user accesses the associated streaming media via its web page.

At step 104, the MPH statistics collector module begins collecting data as soon as the associated streaming media is accessed. The MPH statistics collector module is client-side technology that monitors a user's experience as they interact with the streaming media on a web page. Some of the multitude of statistics the MPH statistics collector module gathers includes, but is not limited to, the ID of the streaming media being played, the type of player being used (Windows Media Player, Real Player, etc.), the connection speed from the client-side to the web page server, the number of lost packets of media data, the number of recovered packets of media data, reception quality, what the client time zone is, how many times the stream switcher switched over to another provider, how many providers were tried, and which provider was chosen. Just before the associated web page is exited, the statistics gathered by the MPH process are sent to a server-side database for storage. The analysis of such MPH gathered statistics as the client time zone, client IP address, and provider chosen has implications for technology that selects the best streaming media hosting provider based upon previous client information and experience. For example, it may be possible to determine, based on data from the MPH statistics collector, that streaming media accessed in the Denver, Colorado area at 4 p.m. (CST) at 120 bandwidth is best hosted by Intervu. This information can serve to intelligently determine the best starting point for MPH.

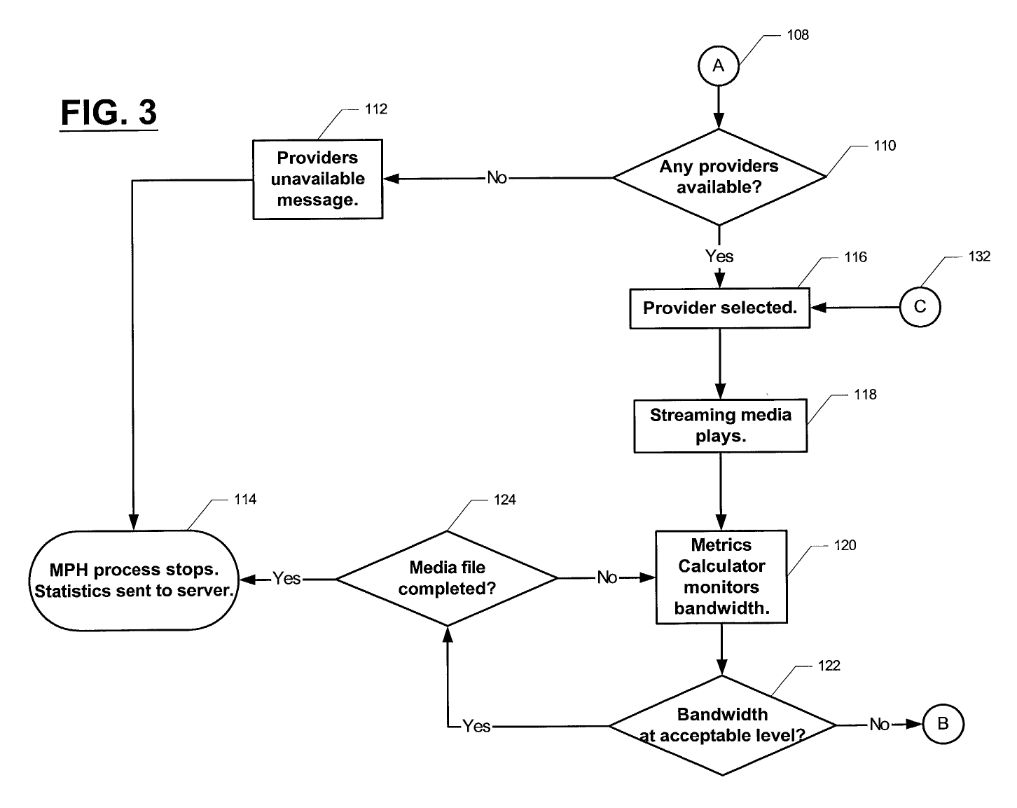

The MPH sniffer module is a client-side application that is triggered at step 106 by user access of the streaming media web page. It calculates the current bandwidth from the client machine to the web page server, checks to see whether the client has the necessary components required to experience the streaming media, etc. The information gathered by the sniffer module gives the MPH process an initial determination of where to start in the provider selection process. Processing continues on FIG. 3 as shown by continuation indicator 108.

With reference to decision block 110, the MPH system begins checking the availability of its selection of streaming media hosting providers-if need be, exhausting its entire list of providers. If none of the providers on the MPH list is available, MPH sends to the user at step 112 a message announcing that the streaming media cannot be viewed at the present time. In addition to such a message, a client-side script can be executed that can, for example, redirect the user to a non-streaming media web page. The MPH process then stops at end block 114, and data from the statistics collector is sent to the server-side database.

If the MPH process finds an available provider to host the streaming media, it selects that provider at step 116. During its first pass through the list of providers, the MPH process selects the first available provider and uses it to begin streaming the media file. Later in the MPH process, if the first provider fails to maintain acceptable bandwidth, the next available provider on the list is selected to continue hosting the media file. Finally, if none of the available providers meets the minimum bandwidth requirement, the MPH process selects the provider that has the best recorded bandwidth of those available.

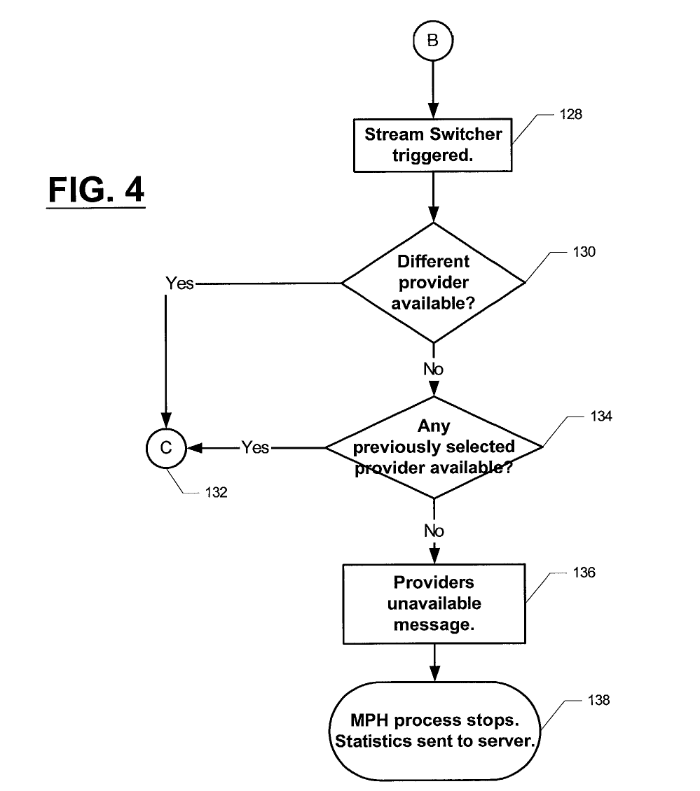

Once the provider is selected, the streaming media begins to play at step 118. During streaming media play, the MPH metrics calculator module monitors at step 120 the bandwidth of the streaming media being received on the client-side, comparing that measurement to the predetermined percentage of bandwidth considered to be the minimum required for an acceptable user experience. At set intervals, the MPH metrics calculator module checks at decision bock 122 to see whether the current bandwidth is at the acceptable level. If the current bandwidth is at an acceptable level, and the streaming media has not yet completed play duration as determined by decision block 124, the MPH metrics calculator module continues monitoring bandwidth at step 120 from the same provider. If the streaming media has completed its play duration, the MPH process completes at stop block 114 by sending all data from the statistics collector to the server-side database. If bandwidth is determined by the metrics calculator module to be below the acceptable level, the MPH stream switcher module is triggered at step 128 on FIG. 4.

After the stream switcher module is triggered at step 128, the stream switcher module pauses the media stream, records the current play time, and begins checking through the list of providers for the next available one. At decision block 130, the stream switcher module looks for the next available provider who has not yet been selected. If it finds one, that provider is selected, the play time of the stream is set to the time recorded in step 128, the media continues streaming, bandwidth is monitored, and the MPH process continues on FIG. 3 as indicated by continuation indicator 132.

If the MPH stream switcher module determines that all providers on the list have been selected before, it searches through the recorded bandwidth of all providers, and checks availability at decision block 134. Of the providers available, the stream switcher module selects the one with the best recorded bandwidth and processing continues on FIG. 3 as indicated by continuation indicator 132.

If none of the providers on the MPH list is available, the MPH process sends the user at step 136 a message announcing that viewing of the streaming media cannot be continued at the present time. The MPH process stops at stop block 138, and data from the statistics collector is sent to the server-side database.

The MPH system and method, described above, provide many advantages over other known streaming techniques. These advantages include: (1) the use of multiple providers greatly enhances the odds of availability and quality of streaming media; (2) except for the rare situation in which all providers are offline, viewers of streaming media with MPH capabilities will not receive an error saying the media is not available; (3) by constantly monitoring the bandwidth of the stream, in real-time, MPH detects when it drops below an acceptable level, and can switch to another provider; (4) the use of client-side metrics increases the accuracy of assessing end user needs, and improves the chances of detecting and correcting drops in quality in the delivery of streaming media.

Having described in detail the preferred embodiments of the present invention, including the preferred methods of operation, it is to be understood that this operation could be carried out with different elements and steps. This preferred embodiment is presented only by way of example and is not meant to limit the scope of the present invention which is defined by the following claims.

It is claimed:

1. A client-side apparatus for handling media capable of being provided by a plurality of provider computer systems to a client computer, comprising:
a sniffer module for use on the client computer that determines capabilities of the client computer related to handling the media;
wherein a first provider computer system is selected based upon the determined capabilities of the client computer, and a network connection is to be established so that the selected first provider computer system may provide the media to the client computer;
a metrics calculator module for use on the client computer that examines a connection characteristic of the network connection as the media is being delivered from the first provider computer system to the client computer; and
a stream switcher module for use on the client computer that includes a data pathway to the metrics calculator module, said stream switcher module ceasing delivery of the media from the first computer provider based upon the examined connection characteristic satisfying a preselected criterion, said stream switcher module selecting a second computer provider to deliver the remaining portion of the media to the client computer.

2. The apparatus of claim 1 wherein the media includes streaming media, said streamed media including video and audio data.

3. The apparatus of claim 1 wherein the provider computer systems are streaming media providers.

4. The apparatus of claim 1 wherein the sniffer module examines whether the client has the necessary components required to experience the media.

5. The apparatus of claim 4 wherein the sniffer module determines bandwidth for delivering the media to the client computer, wherein a first provider computer system is selected based upon the determined capabilities of the client computer and the determined bandwidth.

6. The apparatus of claim 1 wherein during streaming of the media, the metrics calculator module monitors bandwidth of the streaming media being received on the client-side, and compares that measurement to a predetermined percentage of bandwidth considered to be the minimum required for an acceptable user experience.

7. The apparatus of claim 6 wherein if the metrics calculator determines the bandwidth to be below the acceptable level, then the stream switcher module pauses the media stream, records current play time of the media stream, and examines a list of provider computer systems for the next available one to deliver the remaining portion of the media.

8. The apparatus of claim 6 wherein the network connection includes an Internet connection over which the media is delivered to the client computer.

9. The apparatus of claim 1 further comprising:
a provider list file that contains available computer provider systems and their associated delivery characteristics,
wherein the first provider computer system is selected based upon a comparison of the determined capabilities and the characteristics contained in the provider list file,
if the first provider computer system does not maintain a bandwidth within a preselected acceptable level, then the next available provider computer system contained in the list is selected to continue hosting the media.

10. The apparatus of claim 9 wherein if none of the provider computer systems on the list is available, then a message is sent to the user announcing that the streaming media cannot be viewed at the present time.

11. The apparatus of claim 10 wherein if none of the provider computer systems on the list is available, then client-side script is executed that redirects the user to a non-streaming media web page.

12. The apparatus of claim 1 further comprising:
a statistics collector module that collects client viewing statistics, and stores these statistics for analysis of the client computer's handling of the media and the provider computer systems' handling of the media.

13. The apparatus of claim 12 wherein the statistics collected by the statistics collector module includes statistics consisting of an identifier of the streaming media being played, type of player being used, connection speed, number of lost packets of media data, number of recovered packets of media data, reception quality, what the client time zone is, how many times the stream switcher switched over to another provider computer system, how many provider computer systems were tried, which provider computer system was chosen, and combinations thereof.

14. The apparatus of claim 12 wherein the collected statistics are sent to a server-side database for storage, wherein the stored statistics are used by a second sniffer module located on a second client computer in order to select a provider computer system to deliver media to the different client computer.

15. The apparatus of claim 1 further comprising:
multiple provider hosting code located on the client computer that is added to code for handling the streaming of the media.

16. The apparatus of claim 15 wherein the code that handles the streaming of the media is hypertext markup language (HTML) code.

17. The apparatus of claim 15 wherein the metrics calculator module examines the connection characteristic when the streaming of the media occurs.

18. The apparatus of claim 1 where delivery optimization occurs in real-time as the media is being received at a client system.

19. The apparatus of claim 18 wherein the preselected criterion is delivery bandwidth, wherein the stream switcher module switches to the second provider computer system in order to ensure streaming media is substantially continuously played at a desired bandwidth.

20. A computer-implemented method for handling media capable of being provided by a plurality of provider computer systems to a client computer, said method being performed on the client computer and comprising the steps of:
determining capabilities of the client computer related to handling the media;
determining bandwidth for delivering the media to the client computer;
selecting a first provider computer system based upon the determined capabilities of the client computer and upon the determined capabilities of the client computer and the determined bandwidth;
establishing a network connection so that the selected first provider computer system provides the media to the client computer;
examining bandwidth of the network connection as the media is being delivered from the first provider computer system to the client computer;
ceasing delivery of the media from the first computer provider based upon the examined bandwidth satisfying a preselected criterion;
selecting a second computer provider to deliver the remaining portion of the media to the client computer;
examining bandwidth of the network connection as the media is being delivered from the second provider computer system to the client computer;
ceasing delivery of the media from the second computer provider based upon the examined bandwidth associated with the second provider computer system satisfying a preselected criterion; and
selecting a third computer provider to deliver the remaining portion of the media to the client computer.
